(19) United States
(12) Patent Application Publication
(10) Pub. No.: US 2007/0181520 A1
(43) Pub. Date: Aug. 9, 2007

(54) Beverage Container Vent Mechanism Including Perforated Elastic Membrane And Support Plate

(75) Inventors: James W. Holley JR., Colorado Springs, CO (US); Patrick T. Bever, Santa Clara, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Insta-Mix, Inc., Subsidiary A (DBA UMIX, Inc.), Colorado Springs, CO (US)

(21) Appl. No.: 11/695,581

(22) Filed: Apr. 2, 2007

Related U.S. Application Data
(63) Continuation-in-part of application No. 11/212,154, filed on Aug. 26, 2005.

(51) Int. Cl. A61J 11/00; A61J 9/04; A61J 9/00

(52) U.S. Cl. 215/11.1; 215/11.5

(57) ABSTRACT

A beverage container assembly includes a thin, silicone membrane that is perforated with multiple pinholes and is mounted on a rigid support plate defining multiple vent holes. The silicone membrane rests against an inside surface of the support plate when the pressure inside the container is equal to or greater than the surrounding environment, and the pinholes remain closed to prevent beverage leakage. When beverage is drawn from the container, the resulting pressure differential causes the membrane to bend inward, which opens the pinholes to allow venting of air into the container. The membrane is formed at the end of an elongated silicone fluid containment member that forms a liner inside a container body.

### RELATED APPLICATION

The present application is a continuation-in-part of U.S. patent application Ser. No. 11/212,154 filed by James W. Holley, Jr. and Patrick T. Bever on Aug. 26, 2005.

### FIELD OF THE INVENTION

The present invention relates to beverage containers, and more specifically it relates to vent mechanisms for regulating internal pressure of bottle-type beverage containers.

### RELATED ART

Bottle-type beverage containers, such as baby bottles, utilize various conventional venting mechanisms that prevent vacuum generation by admitting air into the container to replace the volume of liquid drawn out by a feeding baby through a nipple, thereby allowing a baby to feed without stopping to allow air into the bottle through the nipple.

One such conventional venting mechanisms utilized in baby bottle assemblies includes a slit-like vent hole formed in the flange surrounding a baby bottle nipple, which is secured to a threaded neck of the baby bottle by way of an annular cap. This vent hole is biased into a closed position when the bottle is not in use, and opens to allow the inflow of air in response to lower pressure generated by the feeding baby. A problem with this type of conventional venting mechanism is that the air entering the baby bottle passes through the remaining milk or formula, causing the generation of bubbles that may be subsequently consumed by the baby.

A second type of conventional venting mechanism utilized in baby bottle assemblies is mounted onto a bottom of the bottle and includes a domed diaphragm having several slit-like openings that are biased into a closed position to prevent leakage when the bottle is not in use, and open during use to equalize internal and external pressure. In particular, when the bottle is inverted and internal pressure is generated, air enters through the slit-like openings above the surface of the stored fluid, thereby avoiding the generation of bubbles in the fluid. A problem with such domed diaphragms is that they typically require relatively complicated and expensive manufacturing equipment. In addition, the slit-like vent openings are known to weaken with repeated use and/or to trap solid material that eventually produces tearing along the edges of the slits, which can ultimately cause undesirable leakage.

What is needed is a reliable vent mechanism for a beverage container that is relatively easy to manufacture and avoids the problems associated with conventional venting structures.

### SUMMARY

The present invention is directed to beverage containers that utilize vent mechanisms to allow air into a central chamber as a beverage contained therein is drawn out, thereby equalizing the internal pressure in the beverage container.

In accordance with an embodiment of the present invention, a vent mechanism includes a rigid support plate having one or more open vent holes (openings), and a flow control member including a membrane that is supported between the support plate and a storage chamber of the beverage container. The membrane is a thin, flat elastic sheet that is perforated to include one or more normally-closed pinholes. Because the pinholes are formed on a flat surface, manufacturing of beverage containers in accordance with the present invention is greatly simplified over conventional venting mechanisms that utilize domed diaphragms. In addition, because the pinholes are formed using pins that do not produce slits in the membrane material that can become weakened and/or trap deposits that can prevent slit flap closure, the vent mechanism of the present invention facilitates leak-free operation that is substantially more reliable than that of slit-based conventional venting mechanisms.

In accordance with a specific embodiment of the present invention, a beverage container includes a container body defining a beverage outlet (upper) opening, a flow control (e.g., nipple or nozzle) assembly mounted over the upper opening, and a one-way venting mechanism disposed at a lower end of the container body (i.e., opposite to the beverage outlet). The venting mechanism includes a support member and a vent member. The support member includes a peripheral flange that is either integrally formed with or removably secured to the container body, and a rigid support plate that defines one or more always-open vent holes. The vent member includes a perforated membrane surrounded by an optional, relatively durable collar that is attached to a peripheral edge of the membrane. The collar is secured to the container body by the peripheral flange of the support member, and the membrane includes a thin sheet of a suitable elastomeric material (e.g., soft rubber, thermoplastic elastomer, or silicone) that rests against an inside surface of the support plate when the pressure inside the container is equal to or greater than the surrounding environment. The pinholes are formed in the elastomeric material such that they are biased into a closed position when the membrane is in the resting state (i.e., when internal and external pressures are equalized, or when the membrane is pressed against the support plate by the weight of the stored liquid). When the membrane is stretched from its resting state away from the support plate (e.g., in response to a relatively low internal pressure), the pinholes open to allow air flow into the container. The pinholes are formed by applying radial tension and puncturing the membrane using one or more pins having a substantially circular cross-section, and sized such that each pinhole is closed by the surrounding elastomeric material when the radial tension is removed.

In accordance with an alternative specific embodiment of the present invention, a beverage container assembly includes a container body and an elongated, silicone fluid containment member that is inserted inside the container body. The container body has an upper cylindrical neck portion and a lower rigid support plate defining vent holes, where the lower support plate is connected to the neck portion by elongated ribs or a continuous side wall. The silicone fluid containment member includes relatively thick, substantially cylindrical side walls defining an upper opening at its upper end and having a relatively thin (in relation to the side walls) pinhole membrane integrally formed at its opposing lower end. The silicone fluid containment member is inserted into the shell-like body such that the pinhole membrane abuts the rigid support plate and the upper opening is disposed in the neck portion. A beverage is then inserted into the silicone fluid containment member. A cap including a flow control member is then mounted (e.g., screwed) onto the neck to seal the beverage, and to press the silicone fluid containment member into the shell-like body such that the pinhole membrane is pressed against the rigid support wall. The pinhole membrane functions as described above to vent air into the silicone fluid containment member as beverage is drawn out through the flow control member (i.e., nipple or nozzle). An advantage of this embodiment is that the beverage is entirely contained in silicone, which is believed to provide certain health benefits over some commonly used plastics.

In accordance with another alternative embodiment of the invention, a beverage container assembly includes a resilient container body, a one-way vent valve for allowing air inside the container body, a flexible bladder (fluid reservoir) that is mounted inside the container body for holding a beverage, and a flow control (e.g., nozzle) assembly mounted over an open end of the bladder and secured to the container body. In one specific embodiment the container body includes a rigid support plate integrally formed at its lower end, and the one-way vent valve includes an elastomeric membrane with pinholes formed as described above mounted on an inside surface of the container body over the rigid support plate. During use, manually squeezing the container body causes its internal pressure to increase (i.e., because the one-way vent valve prevents air from escaping the container body), thereby forcing the liquid out of the bladder through the flow control member disposed over the upper end of the bladder. When the manually applied pressure is released, the container body resiliently returns to its original shape, drawing air into the container body through the one-way vent valve. In effect, the one-way vent valve cooperates with the container body to provide a pump for forcing liquid from the bladder through the flow control element, thereby facilitating beverage consumption with the beverage container in any orientation (e.g., upright, horizontal, or upside-down). In another specific embodiment, the flow control assembly includes a one-way valve that allows beverage to exit the bladder, but prevents air flow into the bladder when the manually applied pressure is released. An advantage of this embodiment is that the beverage is entirely contained in the bladder, thereby providing health benefits similar to those discussed above. In addition, because the bladder collapses toward the nozzle, the present embodiment facilitates beverage consumption with the container in an upright position.

The present invention will be more fully understood in view of the following description and drawings.

### BRIEF DESCRIPTION OF THE DRAWINGS

FIG. 1 is a partial cut-away exploded side view showing a baby bottle assembly according to an embodiment of the present invention;

FIGS. 2(A) and 2(B) are top plan and partial cross-sectional side views, respectively, showing a flow control member of the baby bottle assembly of FIG. 1;

FIGS. 3(A) and 3(B) are top plan and cross-sectional side views showing a support member of the baby bottle assembly of FIG. 1;

FIG. 4 is a partial cross-sectional view showing a lower portion of the baby bottle of FIG. 1 with the flow control member in a resting state;

FIGS. 5(A) and 5(B) are enlarged cross-sectional side views showing a portion of the support member and flow control member of the baby bottle of FIG. 1;

FIG. 6 is an exploded, partial cut-away elevation view showing a beverage container assembly according to another embodiment of the present invention;

FIG. 7 is cross-sectional elevation view showing the beverage container assembly of FIG. 6 in an assembled state;

FIG. 8 is an exploded, partial cut-away elevation view showing a beverage container assembly according to another embodiment of the present invention;

FIGS. 9(A) and 9(B) are cross-sectional elevation views showing the beverage container assembly of FIG. 8 in an assembled state;

FIG. 10 is an exploded perspective view showing a flow control element with a one-way valve according to another embodiment of the present invention; and

FIG. 11 is a cross-sectional side view showing the flow control member of FIG. 10 in an assembled state; and

FIGS. 12(A) and 12(B) are cross-sectional side view showing the flow control member of FIG. 10 during operation.

### DETAILED DESCRIPTION

The present invention is described below with specific reference to a baby bottle assembly, which represents one type of beverage container that benefits from the present invention. As used herein, directional terms such as “upper”, “upwards”, “lower”, “downward”, “front”, “rear”, are intended to provide relative positions for purposes of description, and are not intended to designate an absolute frame of reference. In addition, the phrases “integrally connected” and “integrally molded” is used herein to describe the connective relationship between two portions of a single molded or machined structure, and are distinguished from the terms “connected” or “coupled” (without the modifier “integrally”), which indicates two separate structures that are joined by way of, for example, adhesive, fastener, clip, or movable joint. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

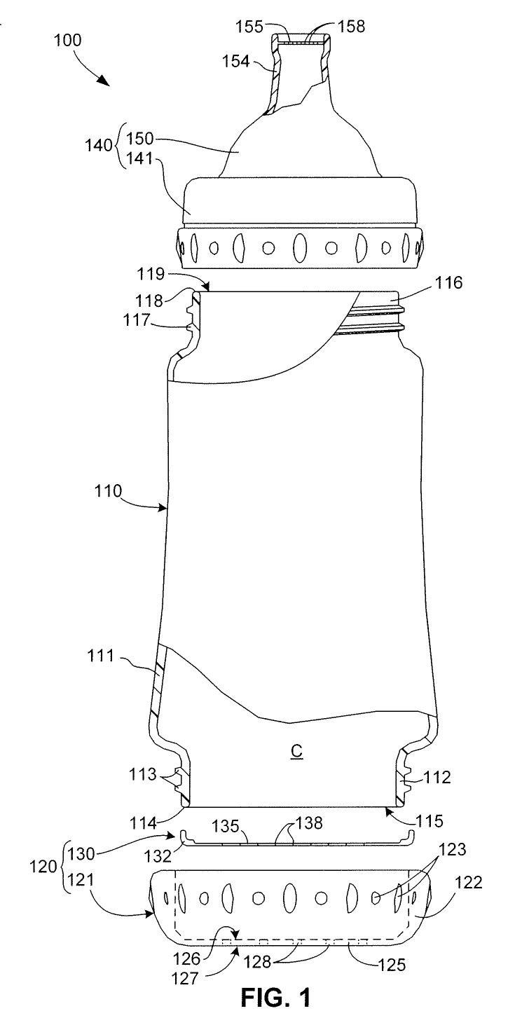

FIG. 1 is a partial cut-away side view showing a baby bottle assembly 100 according to an embodiment of the present invention. Baby bottle assembly 100 generally includes a generally cylindrical bottle (container) body 110, a vent mechanism 120, and a nipple (nozzle) assembly 140.

Bottle body 110 is a plastic structure formed in accordance with known plastic molding techniques. Bottle body 110 includes a roughly cylindrical peripheral wall 111 having a lower (first) end portion 112 that includes external threads 113 and has a lower edge 114 defining a lower (first) opening 115, and an upper (second) end portion 116 that includes external threads 117 and has an upper edge 118 defining an upper (second) opening 119. Peripheral wall 111 surrounds a beverage storage chamber C that is accessible through lower opening 115 and upper opening 119.

Vent mechanism 120 is mounted onto lower portion of bottle body 110 over lower opening 115, and provides the functions described below. Vent mechanism 120 generally includes a support member 121 and a flow control member 130 that are produced separately and assembled onto bottle body as described below.

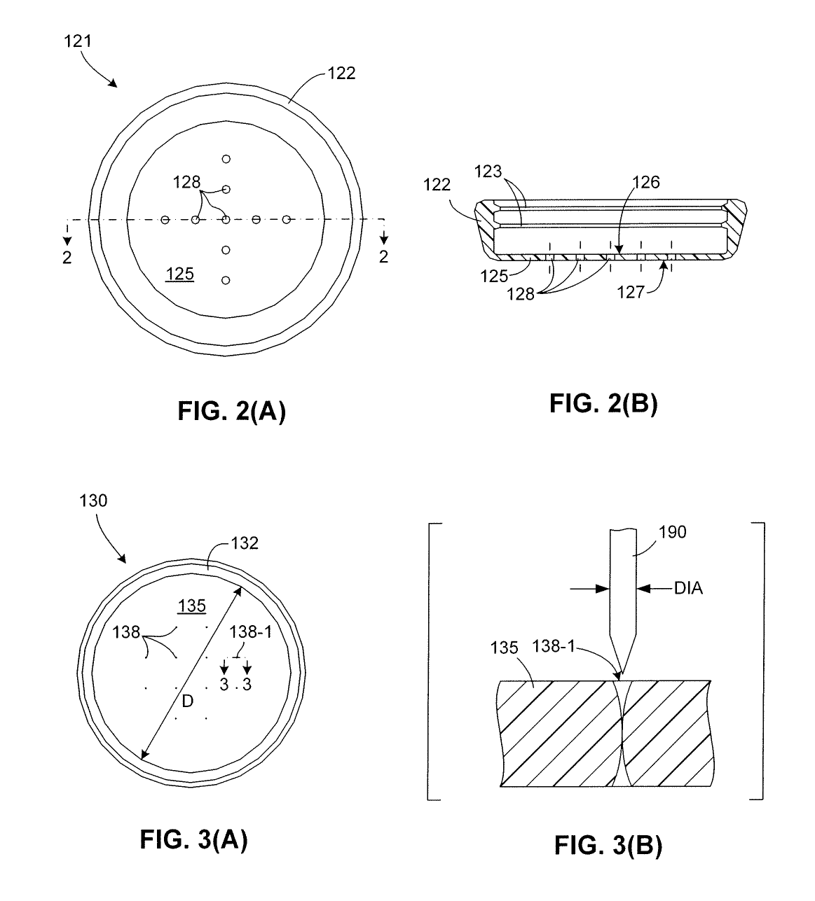

Referring to FIGS. 1, 2(A) and 2(B), support member 121 is a rigid plastic structure formed in accordance with known plastic molding techniques, and includes a collar 122 having inside threads 123 that mate with threads 113 of lower end portion 112, and a rigid support plate 125 that is attached to and supported by collar 122 such that support plate 125 extends over first opening 115. Support plate 125 has an inner surface 126 and an opposing outer surface 127, and defines one or more permanently-open vent holes 128 that extend entirely through support plate 125 between inner surface 126 and outer surface 127.

Referring to FIGS. 1 and 3(A), flow control member 130 includes a relatively thick or otherwise durable peripheral collar 132 and a perforated membrane 135 whose outer edge is suspended in a trampoline-like manner by peripheral collar 132. In accordance with the present invention, membrane 135 includes a sheet of elastomeric material defining a plurality of (e.g., twelve) pinholes 138. In one embodiment, membrane 135 is circular and has a diameter D in the range of 1 and 3 inches, and a thickness in the range of 0.01 to 0.1 inches. As indicated in FIG. 3(B), each pinhole (e.g., pinhole 138-1) is formed by piercing membrane 135 with a pin 190, or other sharp pointed object, such that each pinhole is closed by the surrounding elastomeric material when pin 190 is subsequently removed. In a preferred embodiment, each pin 190 is formed with a continuously curved (e.g., circular) cross section such that each pinhole 138 is substantially circular (i.e., does not have a slit or fold that would be formed by a cutting element having an edge). Note that a pin having a diameter DIA of approximately 0.059 inches was used to produce successful pinholes in a membrane having a diameter of approximately two inches and a thickness of approximately 0.02 inches. In one embodiment, membrane 135 is stretched in a radial direction during the perforation process, thereby facilitating closing of pinholes 138 when the radial tension is subsequently removed.

Referring back to FIG. 1, nipple assembly 140 includes a cap 141 and a nipple 150 that are mounted onto upper end portion (neck) 116 of bottle body 110 in a manner consistent with conventional baby bottles. Cap 141 is a substantially standard structure including a cylindrical base portion having threaded inside surface, and a disk-shaped upper portion that defines a central opening through which a portion of nipple 150 extends. When cap 141 is connected (screwed) onto bottle body 110, the threads formed on the cylindrical base portion mate with threads 117 formed on neck 116. Cap 141 is also molded from a suitable plastic using known methods. Nipple 150 is formed from a suitable elastomeric material (e.g., soft rubber, thermoplastic elastomer, or silicone), and includes a conical wall section 154 extending upward from a base portion (not shown), and a substantially flat, disk-shaped nipple membrane 155 located at the upper portion of upper conical wall section 154. In accordance with an embodiment of the present invention, nipple membrane 155 defines several pinholes 158, which are formed in a manner similar to that described above, to facilitate adjustable liquid flow from storage chamber C through nipple 150. When mounted in bottle assembly 100, a ring-shaped flange portion (not shown) located at a base of nipple 150 is pinched between upper edge 118 of neck 116 and a portion of cap 140.

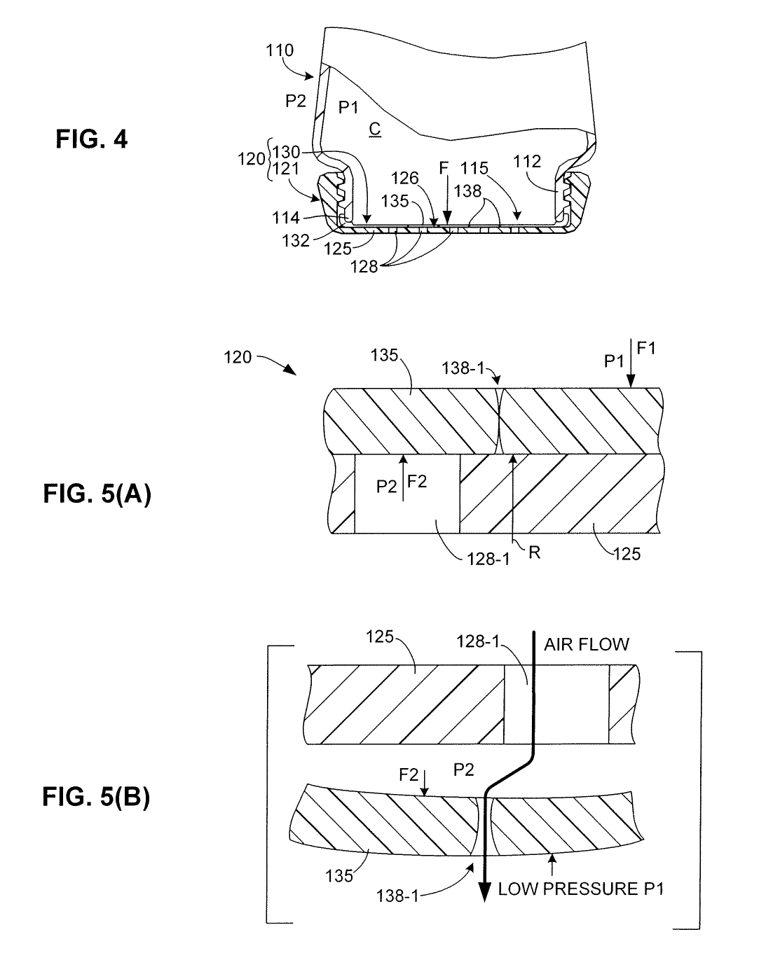

As indicated in FIG. 4, when vent mechanism is mounted on to lower end portion 112 of bottle body 110, peripheral collar 132 is pinched between lower edge 114 and inside surface 126 of support plate 125 (or another structure mounted adjacent to the peripheral edge of support plate 125), thereby supporting membrane 135 such that membrane 135 is positioned between support plate 125 and the storage chamber C. In accordance with an aspect of the invention, membrane 135 is supported such that substantially the entire lower surface of membrane 135 contacts the central portion of support plate 125 when membrane 135 is in an unbiased resting or supported state (i.e., when a pressure P1 inside chamber C is equal to a pressure P outside housing body 110, and/or when membrane 135 is subjected to a sufficient downward force F (e.g., exerted by the weight of a stored liquid) to press membrane 135 against support plate 125).

FIGS. 5(A) and 5(B) respectively illustrate a one-way valve characteristic of vent mechanism 120 that provides pressure equalization (venting) when beverage is drawn out of the baby bottle. As indicated in FIG. 5(A), due to the characteristics of membrane 135, pinhole 138-1 remains closed when membrane 135 is in the resting state, thereby preventing the flow of fluid (liquid or gas) through vent hole 128-1 and membrane 135. That is, while the combination of internal pressure P1 and/or the beverage weight generate a downward force F1 on membrane 135 that is greater than an upward force F2 exerted by external pressure P2, membrane 135 remains substantially planar (i.e., supported by plate 125), and pinhole 138-1 remains closed. In contrast, as shown in FIG. 5(B), when the baby bottle is inverted and beverage is displaced from the baby bottle, e.g., by a feeding baby, the force exerted by the beverage is removed, and the internal pressure P1 is eventually reduced such that the force F2 exerted by the external pressure P2 bends membrane 135 away from support plate 125 (i.e., into the baby bottle). This bending of membrane 135 eventually causes one or more of the pinholes (e.g. pinhole 138-1) to open, thereby admitting air from outside of the bottle into the bottle, thus equalizing pressures P1 and P2. Once pressure is sufficiently equalized, membrane 135 is resiliently biased back into the resting state, thus closing the pinholes and preventing further venting.

Those skilled in the art will recognize that the number of pinholes 138, and the diameter, thickness and flexibility of membrane 135 combine to produce the venting characteristics of the venting mechanism. That is, by forming membrane 125 from a relatively flexible, thin elastomeric sheet, using relatively large pins, or providing a relatively large number of pinholes 138, venting may be caused to occur at a relatively low differential pressure. Conversely, by forming membrane 125 from a relatively stiff, thick elastomic sheet, using relatively small pins, or providing a relatively small number of pinholes 138, venting may be caused to occur at a relatively high differential pressure.

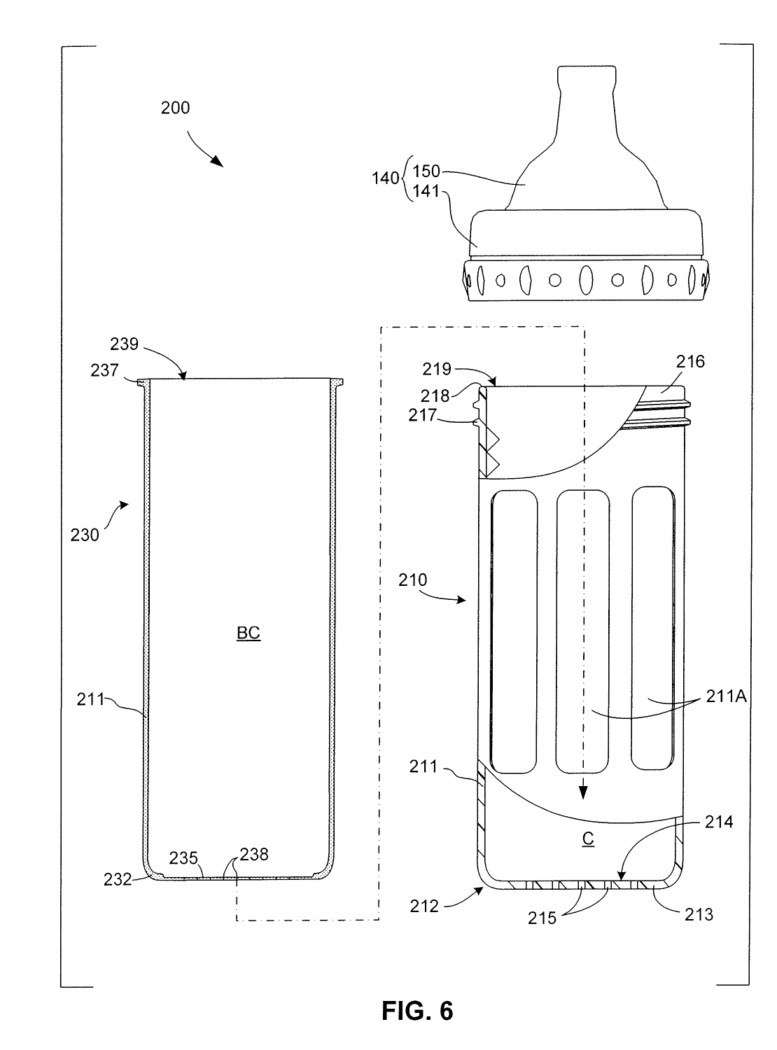

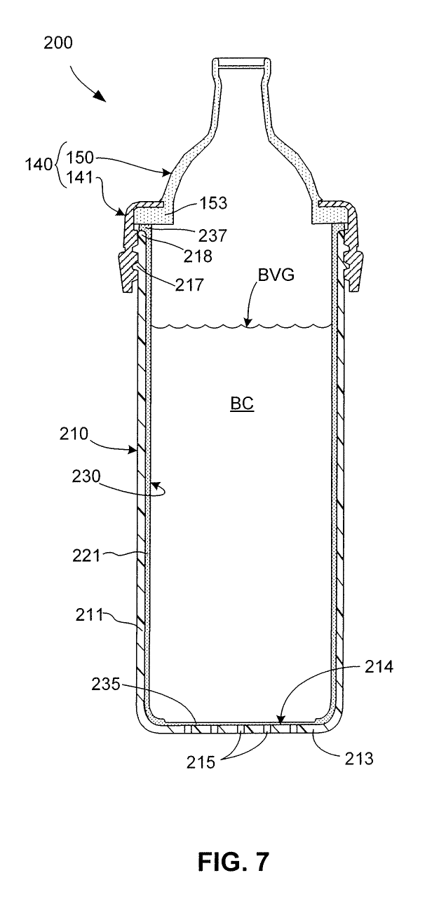

FIGS. 6 and 7 show a beverage container assembly 200 according to another embodiment of the present invention in which the beverage chamber is entirely surrounded by silicone, thereby reducing health risks associated with the use of certain plastics. In particular, beverage container 200 utilizes an elongated silicone fluid containment member 230 that almost entirely surrounds the beverage contained therein. Beverage container 200 also uses nipple (flow control) assembly 140 similar to that described above, which as described below secures silicone nipple 150 over the open end of silicone member 230, thereby entirely surrounding the beverage in silicone.

Referring to the right side of FIG. 6, container body 210 is formed, e.g., from molded plastic or other rigid material to form a frame or shell around silicone member 230. Container body 210 includes a substantially cylindrical shell wall 211 surrounding a central chamber C, and has a lower end portion 212 including an integrally molded rigid support plate 213 defining one or more vent holes 215, and an upper end (neck) portion 216 having a circular edge 218 defining an opening 219. Neck portion 216 includes external threads 218 for connecting to nipple assembly 140. Optional openings or slits 211A are defined in cylindrical wall 211 to facilitate monitoring of beverage levels inside silicone member 230.

Referring to the left side of FIG. 6, silicone member 230 includes a substantially cylindrical liner wall 231 surrounding a beverage chamber BC, a flat membrane 235 integrally molded to the cylindrical wall liner 231 and disposed adjacent to a first end 232 of cylindrical liner wall 231, and an open end portion 236 that includes a collar 237 defining an upper opening 239. Note that cylindrical liner wall 231 is thicker than membrane 235, and membrane 235 defines one or pinholes 238 that are formed in the manner described above (i.e., such that when membrane 235 is in an unbiased resting state, pinholes 238 remain closed, thereby preventing the passage of the beverage, but when the membrane is subjected to an applied force that causes the membrane to bend out of its resting flat shape e.g., toward upper opening 239, pinholes 238 open to allow air into silicone member 230).

In accordance with the present invention, silicone member 230 is inserted as indicated by the dash-dot arrow in FIG. 6 into container body 210 such that, as shown in FIG. 7, flat membrane 235 abuts an inside flat surface 214 of rigid support plate 213, thereby preventing downward (outward) bending of membrane 235. Liner walls 231 are sized to fit snuggly within cylindrical wall 211 of container body 210, and collar 237 is disposed adjacent to upper edge 218 when flat membrane 235 abuts inside flat surface 214. A beverage BVG subsequently inserted into container assembly 200 only contacts silicone member 230. Nipple assembly 140 is then secured onto container body 210 by way of threads 217. Note that a lower flange 153 of silicone nipple 150 is pressed by cap 141 against collar 237 when nipple assembly 140 is properly tightened, thereby pressing membrane 235 against inside surface 214 and forming a reliable seal around upper opening 239.

The subsequent operation of container assembly 200 is similar to that described above with reference to container assembly 100.

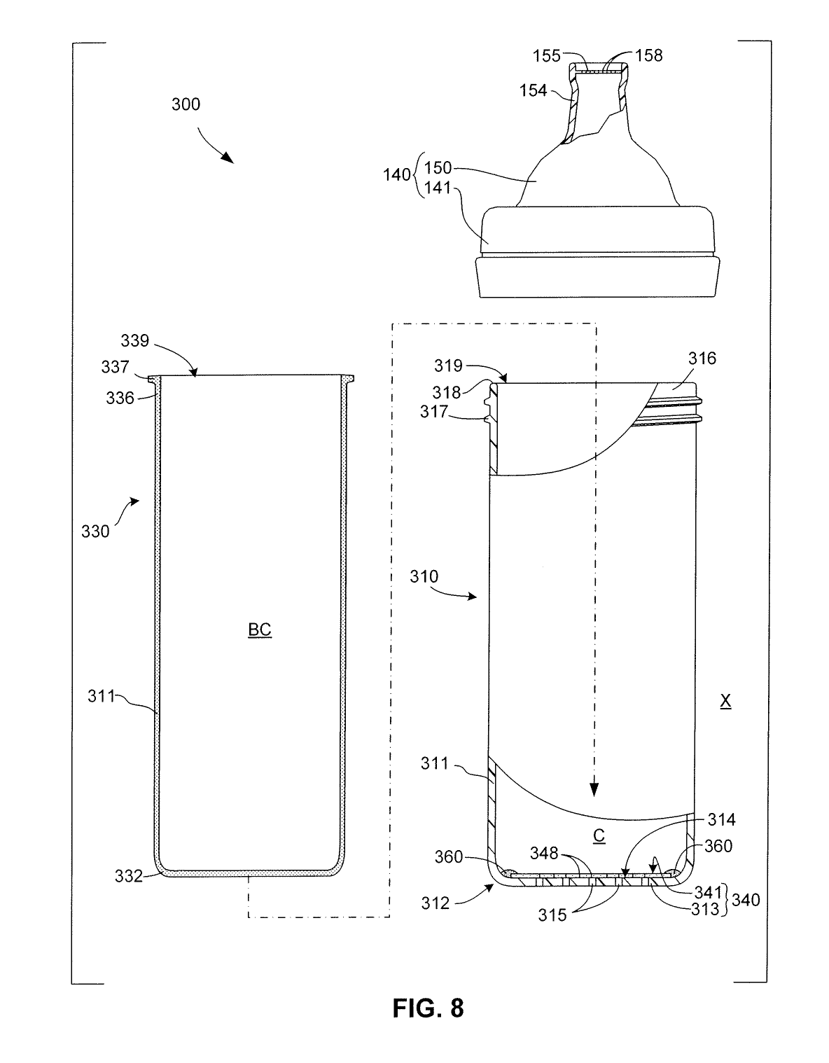

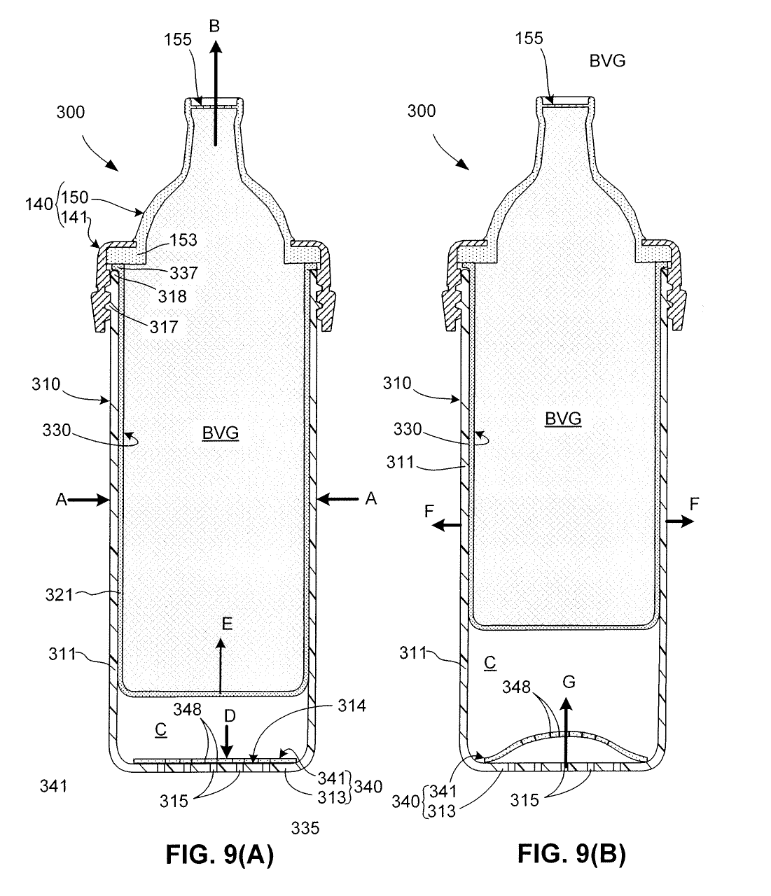

FIGS. 8, 9(A) and 9(B) show a beverage container assembly 300 according to another embodiment of the present invention in which the beverage chamber is defined by a flexible bladder (e.g., polyurethane), thereby reducing health risks associated with the use of certain plastics, and also facilitating beverage consumption with beverage container assembly 300 in an upright position. In particular, beverage container 300 utilizes a bladder (fluid reservoir) 330 that is received inside a container body 310. Beverage container 300 also uses nipple (flow control) assembly 140 similar to that described above, which as described below secures silicone nipple 150 over the open end of bladder 330, thereby securing bladder 330 to beverage container 310, and sealing the beverage inside bladder 330.

Referring to the right side of FIG. 8, container body 310 includes a resilient soft molded plastic or other suitable resilient material that can be easily manually deformed (i.e., squeezed) for the purposes described below. Container body 310 includes a substantially cylindrical outer wall 311 surrounding a central chamber C, and has a lower end portion 312 including a rigid support plate 313 defining one or more vent holes 315, and an upper end (neck) portion 316 having a circular edge 318 defining an opening 319. Neck portion 316 includes external threads 318 for connecting to nipple assembly 140.

In accordance with an aspect of the present invention, a one-way vent valve 340 is disposed at lower end portion 312 of container body 310, and includes an elastomeric (e.g., silicone) membrane 341 disposed on inside surface 314 of support plate 313. As in the embodiments described above, membrane 341 includes one or more pinholes 348 formed such that the one-way valve 340 allows air into container body 310 when an internal pressure inside the central chamber C is less than an external pressure outside central chamber C (e.g., location X), and such that one-way valve 340 prevents air flow out of container body 310 when the internal pressure is greater than the external pressure.

Referring to the left side of FIG. 8, bladder 330 includes an elongated wall 331 surrounding a beverage chamber BC, a closed lower end 332, and an open end portion 336 that includes a collar 337 defining an upper opening 339. As indicated in FIG. 9(A), bladder 330 is inserted into container body 310 such that collar 337 engages upper edge 318 of container body 310 such that bladder 330 is prevented from falling into container body 310. A beverage BVG is then inserted into bladder 330. Note that in some embodiments vent grooves are formed on the inside surfaces of cylindrical walls 311 and/or collar 337 to facilitate the beverage filling process. Note that beverage BVG only contacts bladder 330 and flow control assembly 140, thereby allowing the manufacture of container body 310 using a wide range of materials. As indicated in FIG. 9(A), after insertion of beverage BVG, flow control assembly 140 is secured onto container body 310 by way of threads 317. Note that a lower flange 153 of silicone nipple 150 is pressed by cap 141 against collar 337 when flow control assembly 140 is properly tightened, thereby forming a reliable seal around upper opening 339.

Once container assembly 300 is sealed, air can be purged from bladder 330 by squeezing side walls 311 of container body 310 as indicated by arrows A in FIG. 9(A), which increases the pressure inside central chamber C, thus forcing beverage BVG through membrane 155 of flow control assembly 140. As indicated at the bottom of FIG. 9(A), the increased internal pressure in central chamber C presses membrane 341 against inside surface 314 of support plate 313, thus causing one-way vent vale 340 to close in the manner described above, and preventing air from escaping central chamber C. Thus, beverage BVG can be forced or drawn through upper membrane 155 when container assembly 300 is in any orientation (e.g., upright, as depicted in FIG. 9(A)). Further, as the volume occupied by beverage BVG reduces (i.e., as beverage BVG is drawn out of bladder 330), air is drawn into container body 310 to replace this volume, thereby allowing container body 310 to maintain its cylindrical shape even when bladder 330 is empty.

As indicated in FIG. 9(B), when the manual squeezing force (arrows A in FIG. 9(A)) is removed, side walls 311 resiliently return to their original substantially cylindrical shape (as indicated by arrows F). To facilitate this resilient recovery, one-way valve 340 opens to admit air into central chamber C. In particular, the relatively low pressure inside central chamber C creates a force (indicated by arrow G) on membrane 341 (as depicted by curved membrane The increased internal pressure causes membrane 341 to bow inward, thus opening pinholes 348 and allowing air into central chamber C. Air flows until the pressure is substantially equalized, at which point membrane 341 returns to its unbiased state (indicated in FIG. 9(A)).

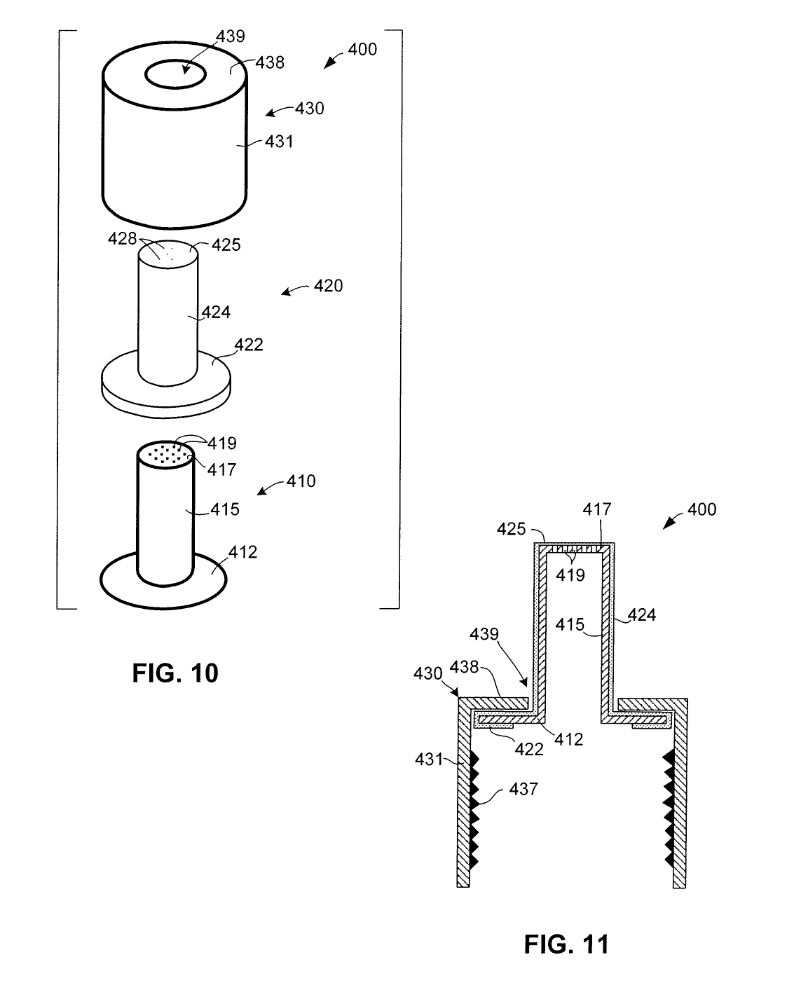

FIGS. 10 and 11 are exploded perspective and cross-sectional side views depicting a flow control assembly 450 according to another embodiment of the present invention. In one embodiment, flow control assembly 400 is utilized in place of flow control assembly 150 in container assembly 300 (FIGS. 8, 9(A) and 9(B)) to prevent backflow of air into bladder 330 through the flow control member.

Flow control assembly 400 includes a hard plastic inner member 410, an elastic outer member 420, and a hard plastic cap 430. Inner member 410 includes a disk-like base 412, a cylindrical flow channel 415 extending upward from base 412, and a support plate 417 disposed at an upper end of flow channel 415. Support plate 417 defines several openings 419. Elastic outer member 420, which is formed from a suitable soft material such as soft rubber or silicone, includes a base portion 422, a cylindrical cover 424 and a membrane 425 including multiple pinholes 428 (not shown) that are formed in the manner described above). Note that a thickness of membrane 425 is less than that of cover 424 and base 422. Cap 430 includes a cylindrical base 432 having threads 437 (see FIG. 11) formed on an inside surface thereon, and a disk-like upper plate 438 defining an upper opening 439. As indicated in FIG. 11, inner member 410 is received inside elastic outer member 420 such that base 412 is secured inside a pocket formed by base 422, such that cylindrical flow channel 415 is securely received inside cylindrical cover 417, and such that membrane 425 is disposed on an upper surface of support plate 417. The combined structure including inner member 410 and outer member 420 are then inserted through upper opening 439 of cap 430 such that an upper portion of base 422 contacts an inside (lower) surface of upper plate 438.

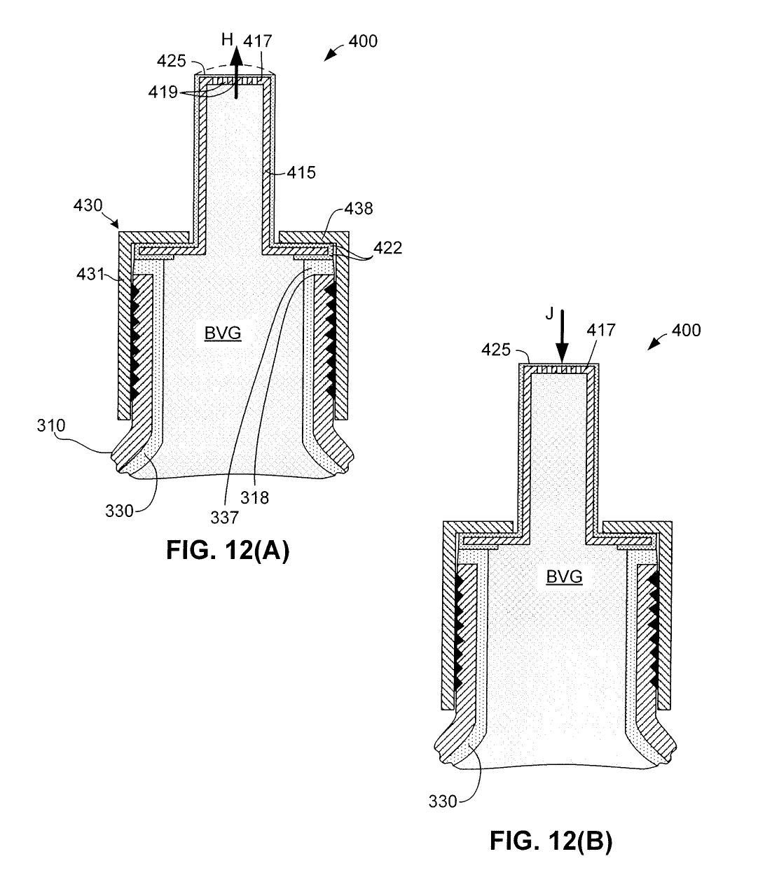

When mounted on upper edge 318 of container body 310, as indicated in FIG. 12(A) and 12(B), flow control assembly 400 provides a second one-way (flow) valve disposed such that beverage BVG flows from bladder 330 when an internal pressure inside container body 310 is greater than an external pressure outside container body 310 (as indicated in FIG. 12(A)), and such that air is prevented from entering bladder 310 through membrane 425 when the internal pressure is less than the external pressure. In particular, as shown in FIG. 12(A), upper collar 337 of bladder 330 and base 422 of outer member 420 are pinched between upper edge 318 of container body 310 and upper plate 438 of cap 430 when cap 430 is connected as shown, thus sealing beverage BVG inside bladder 330 and flow control assembly 400. When a high internal pressure is generated, e.g., by manually squeezing container body 310, the high internal pressure forces beverage BVG through openings 419 of support plate 417 and against membrane 425, which bows outward as indicated by the dashed line, thus opening the pinholes as described below and producing a flow of beverage BVG. Subsequently, as indicated in FIG. 12(B), when the squeezing pressure is removed, the low pressure inside bladder 330 causes a net downward force J on membrane 425, which is prevented by support plate 417 from bowing downward, thereby causing the pinholes to remain closed and preventing air from entering bladder 330.

In addition to the specific embodiment disclosed herein, other features and aspects may be added to the novel baby bottle nipple that fall within the spirit and scope of the present invention. For example, the embodiments shown in FIGS. 8-12 may be implemented using other types of one-way valves (e.g., dome-type vents and/or bite-type valves) to facilitate venting and/or beverage flow. In addition, the beverage container assemblies shown herein may be utilized for non-beverage liquids or pastes (i.e., other plastic materials). Therefore, the invention is limited only by the following claims.

1. A beverage container assembly comprising:
a container body including an elongated wall surrounding a central chamber;
a neck portion disposed at a first end of the elongated wall and defining a circular edge;
a rigid support plate defining one or more vent holes disposed at a second end of the elongated wall; and
a flat elastomeric membrane disposed against a flat inside surface of said rigid support plate, said membrane defining at least one pinhole.

2. The beverage container assembly according to claim 1, wherein said elastomeric membrane comprises elastomeric material characterized in that said at least one pinhole is closed by the elastomeric material surrounding said each pinhole when the membrane is in an unbiased resting state against the flat inside surface of said rigid support plate, thereby preventing passage of a fluid through the membrane, and said at least one pinhole being opened when the membrane is subjected to an applied force that causes at least a portion of the membrane to bend away from the rigid support plate toward the neck portion, thereby facilitating air flow through the membrane.

3. The beverage container of claim 2, wherein flat elastomeric material comprises one of soft rubber, thermoplastic elastomer, and silicone.

4. The beverage container assembly according to claim 1, wherein the elastomeric membrane has a circular outer perimeter having a diameter of 1 to 3 inches and a thickness of 0.01 to 0.1 inches, and wherein the membrane comprises a plurality of pinholes.

5. The beverage container assembly according to claim 1, further comprising a silicone member having a substantially cylindrical liner wall surrounding a beverage chamber, said liner wall having a first thickness,
wherein said elastomeric membrane is integrally molded to said cylindrical liner wall adjacent to a first end of said cylindrical liner wall, and
wherein a second end portion of said cylindrical liner wall defines a collar that is disposed on the circular edge of said container body.

6. The beverage container assembly according to claim 5, further comprising a nipple assembly mounted on the neck portion of the container body.

7. The beverage container assembly according to claim 6, wherein the nipple assembly comprises a silicone nipple including a lower flange, the nipple assembly also including a cap mounted onto the second end portion of said container body such that said lower flange is pressed against the collar of the silicone member.

8. The beverage container of claim 7, wherein the silicone nipple further comprises a flat second membrane formed from an elastomeric material and defining a plurality of second pinholes, wherein the second pinholes are formed such that each second pinhole is closed by the elastomeric material surrounding said each pinhole when the second membrane is in a resting state, thereby preventing fluid flow through the second membrane, and each second pinhole is opened when the nipple is subjected to an applied force that causes the membrane to bend, thereby facilitating fluid flow through the membrane.

9. The beverage container of claim 1, further comprising a flexible bladder disposed inside the container body and having a collar defining a bladder opening, wherein the collar is received in the neck portion such that beverage inserted through the neck opening into the container body is received inside the bladder.

10. The beverage container of claim 9, wherein the bladder comprises polyurethane.

11. The beverage container of claim 9, further comprising a flow control assembly disposed over the bladder opening and including an outlet arranged such that a beverage disposed in the bladder is forced through the outlet when the internal pressure is greater than the external pressure.

12. The beverage container of claim 9, wherein the flow control assembly further comprises a one-way flow valve disposed such that beverage flows from the bladder through the flow control element when an internal pressure inside the container body is greater than an external pressure outside the container body, and such that air is prevented from entering the bladder through the flow control membrane when the internal pressure is less than the external pressure.

13. A beverage container assembly comprising:
a container body including a rigid support plate defining one or more vent holes, a cylindrical neck portion having a circular edge defining an opening, and a rigid member connected between the rigid support plate and the neck portion; and
an elongated fluid containment member including a flat elastomeric membrane disposed adjacent to the rigid support plate, a tube-like neck portion extending through the cylindrical neck portion of the frame, and a side wall extending between the flat membrane and the tube-like neck portion,
wherein said flat membrane defines at least one pinhole.

14. The beverage container assembly according to claim 13,
wherein the side wall of the elongated fluid containment member comprises silicone having a first thickness, and
wherein the flat elastomeric membrane of the elongated fluid containment member comprises silicone having a second thickness, the first thickness being greater than the second thickness.

15. The beverage container assembly according to claim 13, wherein the flat elastomeric membrane, tube-like neck portion and the side wall comprise an integrally molded member.

16. An assembly comprising:
a container body surrounding a central chamber and defining a first opening;
a first one-way vent valve disposed on the container body;
a flexible bladder disposed in the central chamber and defining a second opening that communicates with the first opening; and
a flow control assembly disposed over the first and second openings and including an outlet arranged such that a plastic material disposed in the bladder is forced through the outlet when the internal pressure is greater than the external pressure.

17. The beverage container of claim 16, wherein the bladder comprises polyurethane.

18. The beverage container of claim 16, wherein the flow control assembly further comprises a one-way flow valve disposed such that the plastic material flows from the bladder through the flow control element when an internal pressure inside the container body is greater than an external pressure outside the container body, and such that air is prevented from entering the bladder through the flow control membrane when the internal pressure is less than the external pressure.
